(19) United States
(12) Patent Application Publication
(10) Pub. No.: US 2013/0273776 A1
(43) Pub. Date: Oct. 17, 2013

(54) Conversion Adaptor and LCD Inspection System

(71) Applicants: Mingfeng Deng, Shenzhen (CN); Jungmao Tsai, Shenzhen (CN); Songxian Wen, Shenzhen (CN); Yizhuang Zhuang, Shenzhen (CN)

(72) Inventors: Mingfeng Deng, Shenzhen (CN); Jungmao Tsai, Shenzhen (CN); Songxian Wen, Shenzhen (CN); Yizhuang Zhuang, Shenzhen (CN)

(73) Assignee: SHENZHEN CHINA STAR OPTOELECTRONICS TECHNOLOGY CO LTD., Shenzhen (CN)

(21) Appl. No.: 13/576,400

(22) PCT Filed: Apr. 18, 2012
(86) PCT No.: PCT/CN12/74233

§ 371 Date: Aug. 1, 2012

(30) Foreign Application Priority Data
Apr. 16, 2012 (CN) 201210111033.4

(51) Int. Cl. H01R 27/00; H01R 13/66

(52) U.S. Cl. 439/620.01; 439/638

(57) ABSTRACT

The present invention publishes a conversion adaptor used for LCD panel inspection. The conversion adaptor comprises in order: a first connector plug, an adaptor main body, and a second connector plug; wherein, the first connector plug is used to connect to the connector of a test signal source, and the second connector plug is used to connect to the connector of a connecting cable to an LCD device. The present invention also includes an LCD inspection system. By adding a conversion adaptor, the present invention prevents damage done to the test signal source caused by frequent plugging and unplugging of LVDS cables from its external connector.

### FIELD OF THE INVENTION

The present invention relates to the field of product testing, and more particularly, relates to a conversion adaptor and a Liquid Crystal Display (LCD) inspection system.

### BACKGROUND OF THE INVENTION

Thin Film Transistor Liquid Crystal Display (TFT LCD) has become an important video display product in the modern IT environment. Its main operating principle works by loading an appropriate voltage on the liquid crystal layer between the array glass substrate and color filter glass substrate, making the liquid crystal molecules in the liquid crystal layer deflect. By varying the voltage applied, TFT LCD controls its penetration rate and hence achieves its displaying function.

In order to guarantee the quality of LCD manufactured, LCD module plants need to perform thorough inspection of display panels in quality inspection stations such as lighting inspection, shipment inspection, and double check inspection. At these inspection stations, each LCD is connected to a test signal source through a Low-Voltage Differential Signaling (LVDS) cable in order for the actual inspections to be performed.

Under existing technologies, it is a common practice that LVDS cables are used to directly connect between the LVDS interface of LCD devices and the printed circuit board (PCB) of the test signal source. The diagram in FIG. 1 shows an LCD inspection system based on existing technologies. As illustrated, the LCD inspection system includes: test signal source 11, LCD panel 12, LVDS cable 13, connector 14 of LVDS cable 13 for connecting to test signal source 11, connector 15 between LCD panel 12 to be lit and LVDS cable 13, and external connector 16 of test signal source 11 for connecting with LVDS cable 13.

Since test signal source 11 can be matched to different models of LCD products 12, different LVDS cables 13 needs to be used for connecting to different LCD products. During production, LCD products are frequently switched between different models for inspection. External connector 16 of the test signal source is frequently plugged and unplugged by the LVDS cable connectors 14. It is likely that this frequent plugging and unplugging action can cause damages or failure of the external connector of the test signal source.

### SUMMARY OF THE INVENTION

The technical issue to be addressed by the present invention is to provide a conversion adaptor and an LCD inspection system that can prevent damages to the external connector of the test signal source caused by frequent plugging and unplugging of Low-Voltage Differential Signaling cables.

An embodiment of the present invention provides a conversion adaptor to be used in LCD screen inspections. The conversion adaptor comprises in order: a first connector plug, an adaptor main body, and a second connector plug. Wherein, the first connector plug is used to connect to an external connector of a test signal source, the second connector plug is used to connect to a connector from an LVDS cable connected to an LCD panel, and the adaptor main body includes an electrostatic protection circuit.

According to the embodiment of the present invention, wherein the electrostatic protection circuit includes a transient voltage suppressor which connects in series with the signal line or the power line of the conversion adaptor and ground; the transient voltage suppressor maintains the voltage of the signal line or the power line of the conversion adaptor below a clamping voltage.

According to the embodiment of the present invention, wherein the second connector is a snap connector.

Another embodiment of the present invention provides a conversion adaptor to be used in LCD screen inspections. The conversion adaptor comprises in order: a first connector plug, an adaptor main body, and a second connector plug. Wherein, the first connector plug is used to connect to an external connector of a test signal source, the second connector plug is used to connect to a connector from a connecting cable connected to an LCD panel.

According to the embodiment of the present invention, wherein the adaptor main body includes an electrostatic protection circuit.

According to the embodiment of the present invention, wherein the electrostatic protection circuit includes a transient voltage suppressor which connects in series with the signal line or the power line of the conversion adaptor and ground; the transient voltage suppressor maintains the voltage of the signal line or the power line of the conversion adaptor below a clamping voltage.

According to the embodiment of the present invention, wherein the connecting cable is a Low-Voltage Differential Signaling (LVDS) cable.

According to the embodiment of the present invention, wherein the second connector is a snap connector.

Another embodiment of the present invention provides an LCD inspection system. The LCD inspection system includes: a test signal source, a conversion adaptor, an LVDS cable, and an LCD panel. Wherein, the test signal source includes a first connector; the conversion adaptor comprises in order: a first connector plug, an adaptor main body, and a second connector plug, with the adaptor main body located in the middle of the conversion adaptor; the LVDS cable comprises a second connector at one end, and a third connector at the other end; and the LCD panel includes a fourth connector. Wherein, the first connector of the test signal source connects to the first connector plug of the conversion adaptor; the second connector plug of the conversion adaptor connects to the second connector of the LVDS cable; and the third connector of the LVDS cable connects to the fourth connector of the LCD panel.

According to the embodiment of the present invention, wherein the adaptor main body comprises a signal line and a power line where a transient voltage suppressor is connected in series between the signal line or the power line and ground.

According to the embodiment of the present invention, wherein the LCD panel is a thin film transistor liquid crystal display panel.

According to the embodiment of the present invention, wherein the second connector plug is a snap connector plug.

The present invention brings the following advantages. Different from existing LCD inspection technologies which connect a test signal source directly to an LCD panel using an LVDS cable, the present invention introduces an additional conversion adaptor between a test signal source and a cable connecting to an LCD. This conversion adaptor comprises in order: a first connector plug, an adaptor main body, and a second connector plug. The first connector plug is used to connect to the connector of the test signal source, and the second connector plug is used to connect to the connector of the cable connected to the LCD device. By introducing the additional conversion adaptor, the connecting cable from LCD device no longer connects directly to the external connector of the test signal source, preventing damages to the external connector of the test signal source caused by frequent plugging and unplugging when switching between different types of LVDS cables.

### BRIEF DESCRIPTION OF THE DRAWINGS

FIG. 1 shows the schematic diagram of an LCD inspection system based on existing technologies.

FIG. 2 shows the schematic diagram of an LCD inspection system embodiment of the present invention.

FIG. 3 shows the circuit diagram of an electrostatic protection circuit embodiment of the present invention.

FIG. 4 shows the analog diode characteristic curve of the electrostatic protection circuit shown in FIG. 3.

FIG. 5 shows a characteristic curve of the transient voltage suppressor shown in FIG. 3.

FIG. 6 shows another characteristic curve of the transient voltage suppressor shown in FIG. 3.

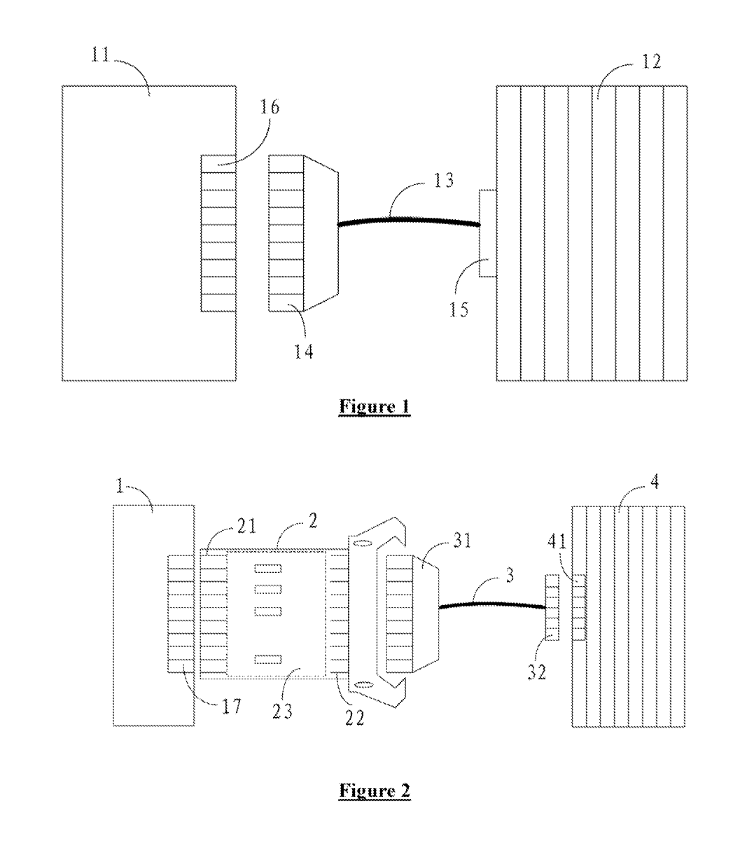

### DETAILED DESCRIPTION OF THE PREFERRED EMBODIMENTS

Under traditional LCD inspection technologies, Low-Voltage Differential Signaling cables are used to connect test signal source directly to LCD panels. In actual production environment, different models of LCD panels requires different types of LVDS cables, resulting in frequent plugging and unplugging from the external connector of the test signal source. The frequent plugging and unplugging action not only causes physical damage to the external connector of the test signal source, it also introduces electrostatic, which reduces the product life of the test signal source.

The present invention shifts the plugging object from the connection between an LVDS cable connector and the test signal source connector to the connection between an LVDS cable connector and a conversion adaptor. FIG. 2 shows the schematic diagram of an LCD inspection system embodiment of the present invention. The LCD inspection system includes: test signal source 1, conversion adaptor 2, LVDS cable 3, and LCD panel 4.

Wherein, test signal source 1 comprises first connector 17; conversion adaptor 2 comprises first connector plug 21, second connector plug 22, and adaptor main body 23 which is enclosed in dotted lines; LVDS cable 3 comprises second connector 31 on one end and third connector 32 on the other end; and LCD panel 4 comprises fourth connector 41.

As shown in FIG. 2, conversion adaptor 2 comprises in order: first connector plug 21, adaptor main body 23, and second connector plug 22; wherein, first connector plug 21 and second connector plug 22 are located at each end of conversion adaptor 2, and adaptor main body 23 is located in the middle of conversion adaptor 2. First connector plug 21 is used to connect to connector 17 of test signal source 1. Second connector plug 22 is used to connect to connector 31 of LVDS cable 3 which is then connected to LCD panel 4.

The actual system is connected as the following: first connector 17 of test signal source 1 connects to first connector plug 21 of conversion adaptor 2; second connector plug 22 of conversion adaptor 2 connects to second connector 31 of LVDS cable 3; and third connector 32 of LVDS cable 3 connects to fourth connector 41 of LCD panel 4.

In other applications, second connector plug 22 could be a snap connector plug, so that the connector can be fixed in place with a snap when second connector plug 22 is connected to connector 31 of LVDS cable 3 which is then connected to LCD panel 4.

By introducing conversion adaptor 2 in the present invention, only the connector of the conversion adaptor which is connected to the LVDS cable needs to be unplugged when switching between different models of LCD panels being inspected. This prevents damages to external connector 17 of test signal source 1 which can be caused by frequent plugging and unplugging from different LVDS cables.

When there is damage caused by connector plugging and unplugging or caused by electrostatic, only the conversion adaptor needs to be replaced. This significantly increases the usage life of the test signal source. Also, the cost of conversion adaptors is far lower than the repair cost of the test signal source. Thus, the present invention also greatly reduces the costs of connector wear and tear.

Wherein, LCD panel 4 includes a TFT LCD panel, etc. Cable 3 for connecting test signal source 1 to LCD panel 4 is an LVDS cable. Test signal source 1 is the device which provides various electronic signals needed during testing.

With existing inspection technologies, when plugging or unplugging connector 16 of test signal source 11 to or from connector 14 of LVDS cable 13, the plugging or unplugging action creates a certain electrostatic effect. The electro-static discharge, ESD, will cause impact to the chips inside the test signal source, hence, causing the test signal source to fail quickly.

FIG. 3 shows a circuit diagram of an electrostatic protection circuit embodiment of the present invention. Adaptor main body 23 comprises a signal line and a power line. To implement the ESD protection function, a Transient Voltage Suppressor, TVS, is connected in series with the signal line or the power line and the ground (Gnd). On the circuit diagram, “In” represents the input end of the current, “Out” represents the output end of the current, and “U_{(TVS)}” represents the line voltage. The current-voltage characteristics of the TVS are similar to characteristics of diodes.

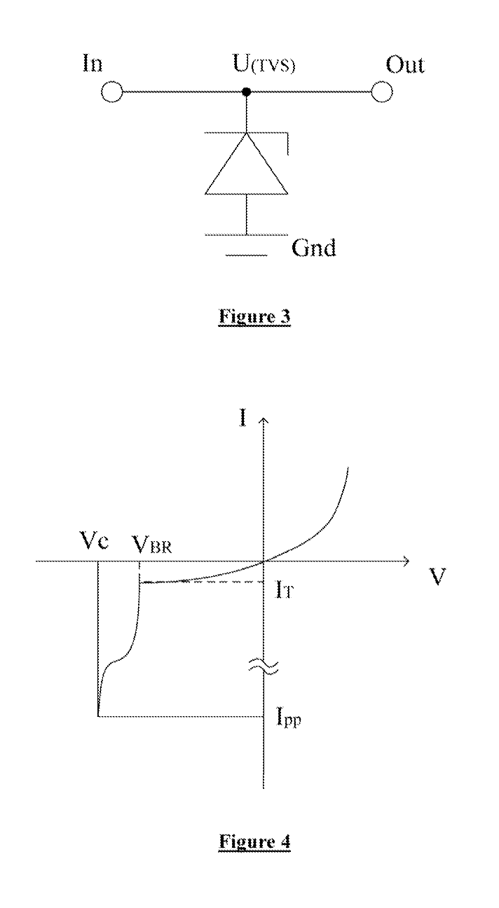

FIG. 4 shows the analog diode characteristic curve of the electrostatic protection circuit shown in FIG. 3. As shown, V_{BR} and I_{T} represent the reverse diode breakdown voltage and current, respectively. V_{c} and Iₚₚ represent the clamped voltage and the peak current after diode breakdown, respectively.

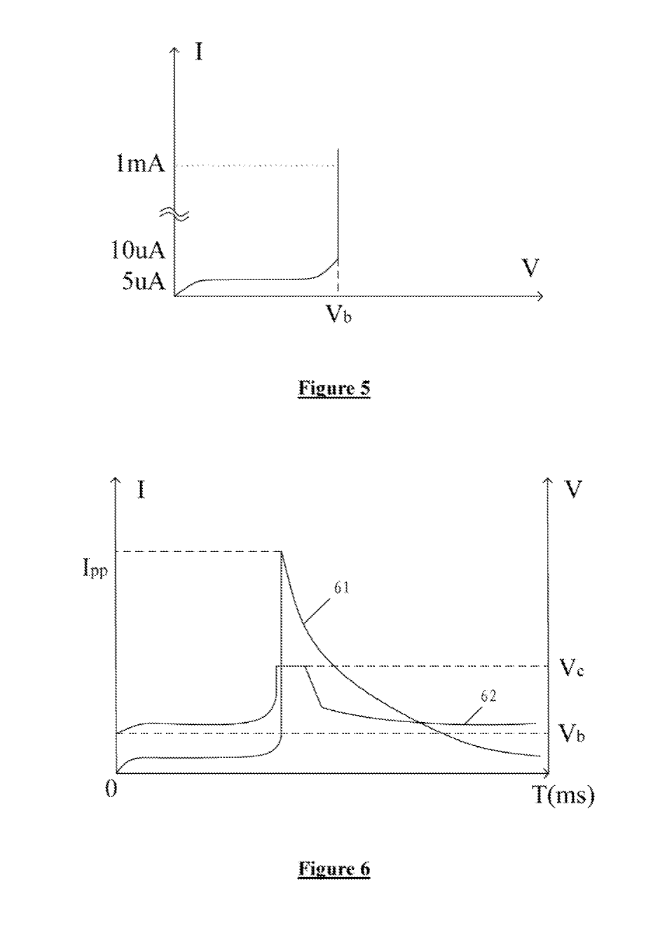

FIGS. 5 and 6 shows the regulator effect of TVS. Both FIG. 5 and FIG. 6 are characteristic curves of the TVS used in the conversion adaptor of the present invention. As shown in FIG. 5, when the current passing through TVS reaches 1 mA, TVS is in the reverse breakdown state. In this state, due to the avalanche effect, internal resistance of TVS dramatically becomes smaller. Current flows directly from TVS to ground, creating a regulator effect.

As shown in FIG. 6, curve 61 represents the current characteristics of the TVS. When the current passing through TVS reaches the maximum Iₚₚ, it starts to decrease exponentially. Curve 62 represents the voltage characteristics of the TVS. The voltage between two ends of TVS is kept below the clamping voltage V_{c}, thus, ensuring the peak transmission voltage does not exceed V_{c}.

In actual operation, when electrostatic is produced by connecting a conversion adaptor to an LCD panel using an LVDS cable, two ends of its TVS is subject to instantaneous high energy impact. The TVS can drastically lowers its internal resistance within 1 ps (1*10-12 seconds), enabling majority of the current to flow to the ground, and hence maintain the voltage between the two ends of the TVS at V_{c}. Thus, TVS protects the test signal source from circuit impacts, and reduce the possibility of failure or damage in the test signal source.

In summary, the present invention changes the way test signal source is connected to an LCD panel being inspected. Instead of directly connect using an LVDS cable, a conversion adaptor with ESD protection mechanism is used instead. This can reduce potential damages being done to the test signal source caused by electrostatic introduced by connector plugging and unplugging actions.

Different from existing LCD inspection technologies which connects test signal source to an LCD panel directly via an LVDS cable, the present invention introduced an additional conversion adaptor to connect between test signal source and an LVDS cable. When swapping between different models of LCD panels, only the connector of the conversion adaptor connected to LVDS cables needs to be unplugged, preventing damages being done to the external connector of the test signal source. In addition, the conversion adaptor contains a TVS. The TVS connects in series with the signal line or the power line of the conversion adaptor and ground, reducing damages to the test signal source caused by electrostatics introduced by plugging and unplugging of connectors.

In other embodiments, a preset voltage breakdown diode can also be used to connect in series with the signal line or the power line and ground, replacing the TVS mentioned above. Negative node of diode connects to the signal line or the power line and positive node connects to ground. This can also prevent damage to electronic chips caused by electrostatics.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A conversion adaptor used for Liquid Crystal Display (LCD) inspection, characterized in that:
the conversion adaptor comprises in order: a first connector plug, an adaptor main body, and a second connector plug;
wherein, the first connector plug is used to connect to the connector of test signal source, the second connector plug is used to connect to the connector of a connecting cable connected to an LCD device, and the connecting cable is a Low-Voltage Differential Signaling cable;
wherein, the adaptor main body comprises an electrostatic protection circuit.

2. The conversion adaptor according to claim 1, characterized in that:
the electrostatic protection circuit includes a transient voltage suppressor which directly connects in series the signal line or the power line of the conversion adaptor and ground; and the transient voltage suppressor maintains the voltage of the signal line and the power line of the conversion adaptor below the clamping voltage.

3. The conversion adaptor according to claim 1, characterized in that:
the second connector plug is a snap connector plug.

4. A conversion adaptor used for Liquid Crystal Display inspection, characterized in that:
the conversion adaptor comprises in order: a first connector plug, an adaptor main body, and a second connector plug;
wherein, the first connector plug is used to connect to the connector of a test signal source and the second connector plug is used to connect to the connector of cable connected to LCD device.

5. The conversion adaptor according to claim 4, characterized in that:
the adaptor main body comprises an electrostatic protection circuit.

6. The conversion adaptor according to claim 5, characterized in that:
the electrostatic protection circuit comprises a transient voltage suppressor which directly connects in series the signal line or the power line of the conversion adaptor and ground; and the transient voltage suppressor maintains the voltage of the signal line or the power line of the conversion adaptor below a clamping voltage.

7. The conversion adaptor according to claim 4, characterized in that:
the connecting cable is a Low-Voltage Differential Signaling cable.

8. The conversion adaptor according to claim 4, characterized in that:
the second connector plug is a snap connector plug.

9. An LCD inspection system, characterized in that:
the inspection system includes: a test signal source, a conversion adaptor, a Low-Voltage Differential Signaling (LVDS) cable, and an LCD panel;
wherein, the test signal source comprises a first connector, the conversion adaptor comprises in order: a first connector plug, an adaptor main body, and a second connector plug, with the adaptor main body located in the middle of the conversion adaptor, the LVDS cable comprises a second connector on one end and a third connector on the other end, and the LCD panel comprises a fourth connector;
wherein, the first connector of the test signal source connects to the first connector plug of the conversion adaptor, the second connector plug of the conversion adaptor connects to the second connector of the LVDS cable, and the third connector of the LVDS cable connects to the fourth connector of the LCD panel.

10. The inspection system according to claim 9, characterized in that:
the adaptor main body includes a signal line and a power line, and a transient voltage suppressor connects in series with the signal line or the power line and ground.

11. The inspection system according to claim 9, characterized in that:
the LCD panel is a thin-film transistor liquid crystal display panel.

12. The inspection system according to claim 9, characterized in that:
the second connector plug is a snap connector plug.
